(19) United States
(12) Patent Application Publication
(10) Pub. No.: US 2006/0165014 A1
(43) Pub. Date: Jul. 27, 2006

(54) Peer-to-peer content distribution system

(76) Inventor: Yasushi Ikeda, Neyagawa-shi (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/255,419

(22) Filed: Oct. 20, 2005

(30) Foreign Application Priority Data
Jan. 26, 2005 (JP) 2005-18336

(51) Int. Cl. H04L 12/28

(52) U.S. Cl. 370/254

(57) ABSTRACT

A system of the present invention includes a center network CE, a cache network CA, and a plurality of realm networks RL1 to RL3. Dynamic peers DP are distributed among the realm networks RL1 to RL3. The center network CE includes a main center server MC and a sub-center server SC. Each realm network includes a sub-center server SC, and forms a P2P system. The cache network CA includes a cache center server CC, and forms a P2P system by a static peer SP and dynamic cache peers CP. Each dynamic cache peer CP in a realm network caches the static peer SP, and thus serves as the source of content distribution in the realm network.

### BACKGROUND OF THE INVENTION

1. Field of the Invention

The present invention relates to a peer-to-peer content distribution system, and more particularly to a hybrid-type peer-to-peer content distribution system including a center server.

2. Description of the Related Art

A peer-to-peer (the abbreviation “P2P” will also be used hereinafter) content distribution system includes a plurality of peers connected to one another. Each peer can download a content item from another peer, and can also send a requested content item to a requesting peer. In a peer-to-peer content distribution system, content items are exchanged between peers, and the file transfer load is distributed among the peers, whereby it is possible to distribute content items among a much larger number of peers (clients) than is possible with a client-server-type content distribution system.

However, at the beginning of distribution of a new content item, there is only a few peers that have the content item stored therein, and the file transfer load is concentrated at those peers, thus resulting in a poor distribution efficiency. Moreover, this problem becomes more pronounced as the number of peers increases.

On the other hand, with pure P2P content distribution systems where there are only peers, it is difficult to keep track of, and control, how content items are exchanged and used, and therefore users of these systems may infringe the copyrights of content items being exchanged. In view of this, a center server may be provided for monitoring the peers. A system of this type is called a “hybrid-type P2P content distribution system” because it is a mix of a P2P system and a client-server system. A problem of such a hybrid-type P2P content distribution system is that the load on the center server increases as the number of peers increases.

Therefore, there is a certain limit on the number of peers and thus on the scale of a P2P content distribution system.

### SUMMARY OF THE INVENTION

It is therefore an object of the present invention to provide a peer-to-peer content distribution system in which the load on each peer is distributed, thereby allowing for the provision of a large number of peers in the system.

Another object of the present invention is to provide a peer-to-peer content distribution system in which the load on the center server can be distributed.

A peer-to-peer content distribution system of the present invention includes a static peer and a plurality of realm networks. Each realm network includes a center server, a dynamic cache peer and a plurality of dynamic peers. The dynamic cache peer is connected to the static peer and the center server. The plurality of dynamic peers are connected to the center server, the dynamic cache peer, and to one another. The static peer includes a first content storage section for storing a content file. Each center server includes a first content information storage section for storing content information regarding particulars (e.g., the title and other meta information) and a location (e.g., URIs (Uniform Resource Identifiers) of the dynamic peers) of each content item. Each dynamic cache peer includes a second content storage section for storing a content file, and a first downloading section for downloading a content file from the static peer to store the downloaded content file in the second content storage section. Each dynamic peer includes: a third content storage section for storing a content file; a section for obtaining content information from the center server in the realm network; a second downloading section for downloading a content file from the dynamic cache peer or another dynamic peer in the realm network based on the obtained content information to store the downloaded content file in the third content storage section; and a content reproduction section for reading out a content file from the third content storage section to reproduce the content item.

In this peer-to-peer content distribution system, peers are distributed among the realm networks, each realm network forming a peer-to-peer system including a center server. Therefore, it is possible to distribute the load among the peers, thus allowing for the provision of a large number of peers. The center servers are also distributed among the realm networks, whereby it is possible to distribute the load among the center servers.

Preferably, the peer-to-peer content distribution system further includes a cache center server. The static peer is connected to the cache center server. The plurality of dynamic cache peers are connected to the cache center server and to one another. The cache center server includes a second content information storage section for storing content information. Each dynamic cache peer further includes a section for obtaining content information from the cache center server. The first downloading section downloads a content file from the static peer or another dynamic cache peer based on the obtained content information.

In such a case, the static peer and the dynamic cache peer also form a peer-to-peer system including the cache center server, which together form a cache network. Therefore, it is possible to reduce the load on the static peer by distributing the load between the static peer and the dynamic cache peer.

Preferably, each dynamic peer further includes a section for notifying the center server of content information of the content item downloaded by the second downloading section. Each dynamic cache peer further includes a section for notifying the cache center server and the center server in the realm network of content information of the content item downloaded by the first downloading section.

In such a case, the dynamic cache peer belongs not only to a realm network but also to a cache network. Therefore, the dynamic cache peer can transfer a content file not only to the dynamic peer but also to another dynamic cache peer.

Another peer-to-peer content distribution system of the present invention includes a main center server and a plurality of realm networks. Each realm network includes a sub-center server and a plurality of peers. The sub-center server is connected to the main center server. The plurality of peers are connected to the sub-center server and to one another. The main center server includes a global peer operation history storage section and a billing section. The global peer operation history storage section stores a peer operation history. The billing section calculates a charge for use of content items based on the peer operation history stored in the global peer operation history storage section. Each sub-center server includes a content information storage section, a local peer operation history storage section and a peer operation history notification section. The content information storage section stores content information regarding particulars of each content item and a location of each content file. The local peer operation history storage section stores a peer operation history of each peer in the realm network representing a history of operation statuses of the peer. The peer operation history notification section notifies the main center server of the peer operation history stored in the local peer operation history storage section. Each peer includes a content storage section, a content information obtaining section, a downloading section, a content reproduction section, and an operation status notification section. The content storage section stores a content file. The content information obtaining section obtains content information from the sub-center server. The downloading section downloads a content file from another peer in the realm network based on the content information obtained by the content information obtaining section to store the downloaded content file in the content storage section. The content reproduction section reads out a content file from the content storage section to reproduce the content item. The operation status notification section notifies the sub-center server of an operation status of itself.

In this peer-to-peer content distribution system, the sub-center server is free from the billing operation and can devote itself to the logging operation of obtaining the operation history of each peer. Thus, it is possible to reduce the load on the center server.

### BRIEF DESCRIPTION OF THE DRAWINGS

FIG. 1 is a network diagram showing a general configuration of a P2P content distribution system according to an embodiment of the present invention.

FIG. 2 is a network diagram showing another configuration of the P2P content distribution system shown in FIG. 1.

FIG. 3 is a functional block diagram showing a configuration of a main center server shown in FIG. 1.

FIG. 4 is a functional block diagram showing a configuration of a sub-center server shown in FIG. 1.

FIG. 5 shows a configuration of a content management database shown in FIG. 4.

FIG. 6 is a network diagram showing a configuration of a center network shown in FIG. 1.

FIG. 7 is a network diagram showing a configuration of a realm network shown in FIG. 1.

FIG. 8 is a functional block diagram showing a configuration of a cache center server shown in FIG. 1.

FIG. 9 is a functional block diagram showing a configuration of a static peer shown in FIG. 1.

FIG. 10 is a functional block diagram showing a configuration of a dynamic cache peer shown in FIG. 1.

FIG. 11 is a functional block diagram showing a configuration of a dynamic peer shown in FIG. 1.

FIG. 12 is a network diagram of a content distribution system illustrating URIs that should be set in a configuration file in peers shown in FIG. 9 to FIG. 11.

FIG. 13 is a flow chart showing an operation of a dynamic peer shown in FIG. 11.

FIG. 14 is a flow chart showing an operation of a dynamic cache peer shown in FIG. 10.

### DETAILED DESCRIPTION OF THE PREFERRED EMBODIMENTS

A preferred embodiment of the present invention will now be described with reference to the drawings. Like elements are denoted by like reference numerals throughout the various figures, and will not be described repeatedly.

General Configuration

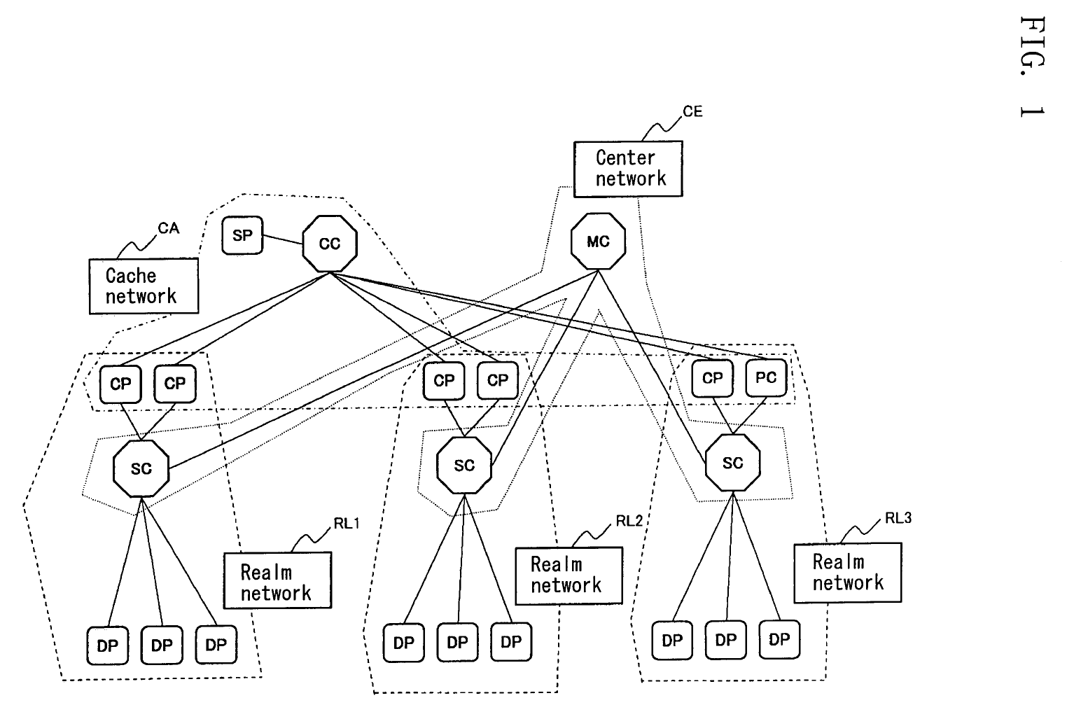

Referring to FIG. 1, a P2P content distribution system according to an embodiment of the present invention includes a main center server MC, a cache center server CC, a static peer SP, and a plurality of realm networks RL1 to RL3. Each of the realm networks RL1 to RL3 includes a sub-center server SC, one or more dynamic cache peers CP, and two or more dynamic peers DP. The main center server MC and the sub-center servers SC together form a center network CE, whereas the cache center server CC, the static peer SP and the dynamic cache peers CP together form a cache network CA.

In the center network CE, each sub-center server SC is connected to the main center server MC via a dedicated telecommunications line such as LAN (Local Area Network) or WAN (Wide Area Network). The main center server MC functions as a server for the sub-center servers SC, and the sub-center servers SC function as clients for the main center server MC. Thus, the center network CE forms a client-server-type system.

A dynamic peer DP is typically a dedicated terminal device of a customer who purchases and uses content items. The main center server MC, the sub-center servers SC, the static peer SP, the cache center server CC and the dynamic cache peers CP are typically operated by content vendors.

In the cache network CA, the static peer SP and the dynamic cache peers CP are connected to the cache center server CC via a dedicated telecommunications line. The static peer SP and the dynamic cache peers CP are also connected to one another (not shown) via a dedicated telecommunications line. The cache center server CC functions as a server for the static peer SP and the dynamic cache peers CP, and the static peer SP and the dynamic cache peers CP function as clients for the cache center server CC. Thus, the cache network CA forms a hybrid-type P2P system including the cache center server CC.

In each of the realm networks RL1 to RL3, the dynamic cache peers CP and the dynamic peers DP are connected to the sub-center server SC via a public telecommunications line such as the Internet. The dynamic cache peers CP and the dynamic peers DP are also connected to one another (not shown) via a public telecommunications line. The sub-center server SC functions as a server for the dynamic cache peers CP and the dynamic peers DP, and the dynamic cache peers CP and the dynamic peers DP function as clients for the sub-center server SC. Thus, the realm networks RL1 to RL3 each form a hybrid-type P2P system including the sub-center server SC.

The static peer SP serves as the source of distribution of a new content item, and uploads newly-registered content information to the cache center server CC. Each dynamic cache peer CP refers to content information obtained from the cache center server CC, and downloads a content item from the static peer SP or another dynamic cache peer CP. Thus, the dynamic cache peer CP becomes a duplicate of the static peer SP. After downloading a content item, the dynamic cache peer CP uploads updated content information to the cache center server CC and also to the sub-center server SC in the realm network to which the dynamic cache peer CP belongs. Thus, each dynamic cache peer CP in a realm network serves as the source of distribution of a new content item in the realm network. Each dynamic peer DP refers to content information obtained from the sub-center server SC, and downloads a content item from a dynamic cache peer CP or another dynamic peer DP.

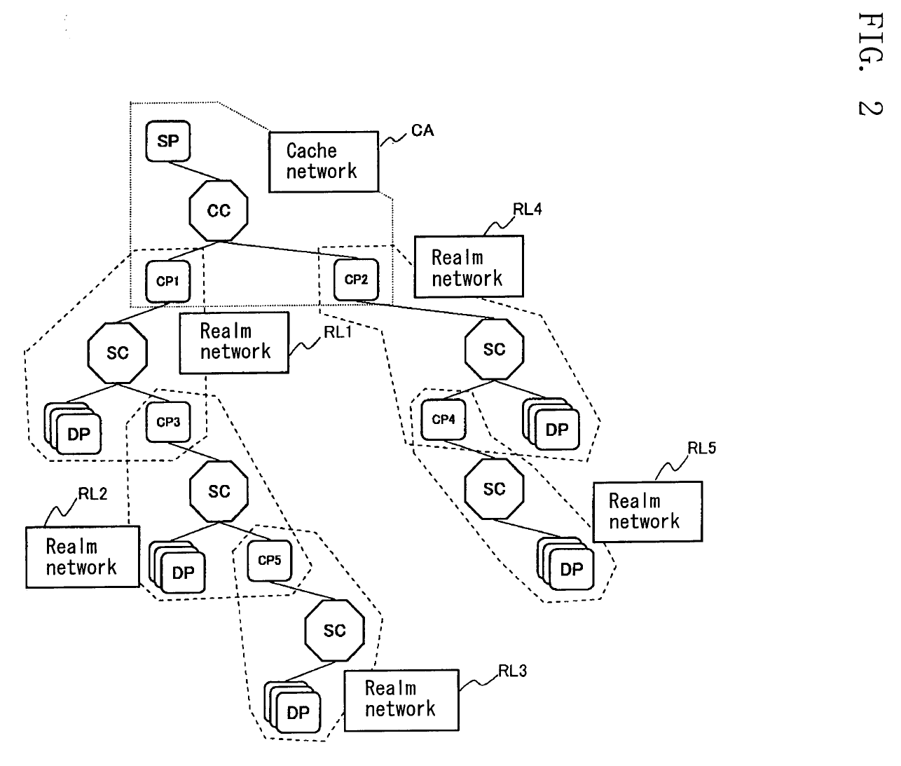

Alternatively, realm networks RL1 to RL5 may be formed in a hierarchical arrangement as shown in FIG. 2. In the illustrated example, the realm network RL1 is placed in the uppermost level in a hierarchy, followed by the realm network RL2 in the following level, which is followed by the realm network RL3 in the following level. The realm network RL4 is also placed in the uppermost level in a hierarchy, followed by the realm network RL5 in the following level.

While dynamic cache peers CP1 and CP2 belong to the cache network CA, dynamic cache peers CP3 to CP5 do not belong to the cache network CA.

The dynamic cache peer CP3 belongs not only to the realm network RL1 but also to the realm network RL2. The dynamic cache peer CP4 belongs not only to the realm network RL4 but also to the realm network RL5. The dynamic cache peer CP5 belongs not only to the realm network RL2 but also to the realm network RL3. Note that the dynamic cache peer CP1 belongs only to the realm network RL1, and does not belong to other realm networks. Similarly, the dynamic cache peer CP2 belongs only to the realm network RL4, and does not belong to other realm networks.

The realm network RL1 is connected to the cache network CA via the dynamic cache peer CP1, the realm network RL2 is connected to the realm network RL1 via the dynamic cache peer CP3, and the realm network RL3 is connected to the realm network RL2 via the dynamic cache peer CP5. The realm network RL4 is connected to the cache network CA via the dynamic cache peer CP2, and the realm network RL5 is connected to the realm network RL4 via the dynamic cache peer CP4.

The dynamic cache peers CP1 and CP2 are called “first-level caches”, the dynamic cache peers CP3 and CP4 are called “second-level caches”, and the dynamic cache peer CP5 is called a “third-level cache”.

Configuration Of Main Center Server

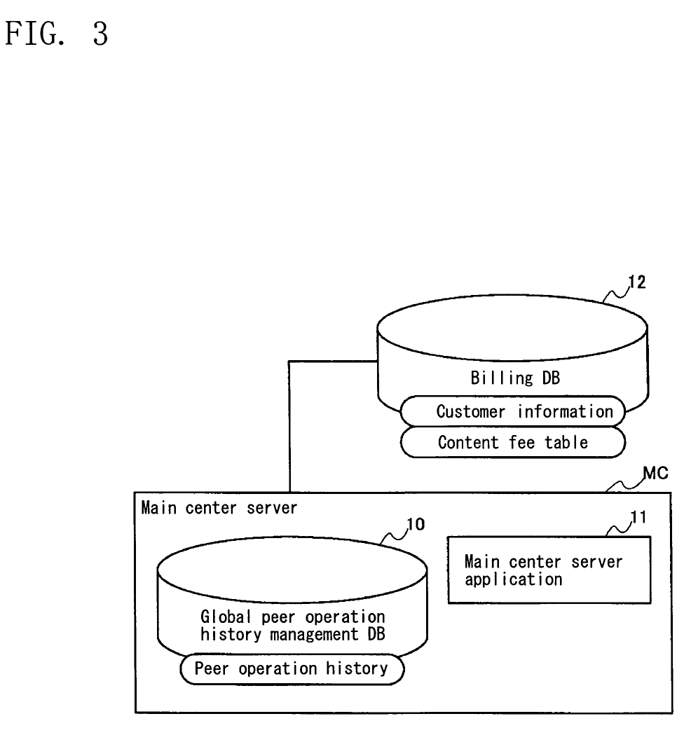

Referring to FIG. 3, the main center server MC includes a global peer operation history management database 10 for storing peer operation histories, and a main center server application 11 for controlling the main center server MC. The peer operation histories stored in the global peer operation history management database 10 are operation histories of all dynamic peers DP. An external billing database 12 is connected to the main center server MC. The billing database 12 contains customer information (e.g., the name, mail address, age, occupation, etc., of each customer), and content fee table (e.g., the fee for each content item, or the fee for a unit time of use of a content item). Specifically, the main center server application 11 stores the peer operation history sent from each sub-center server SC in the global peer operation history management database 10, calculates the charge for the use of content items for each dynamic peer DP based on the peer operation history and information contained in the billing database 12, and performs a billing operation.

Configuration Of Sub-Center Server

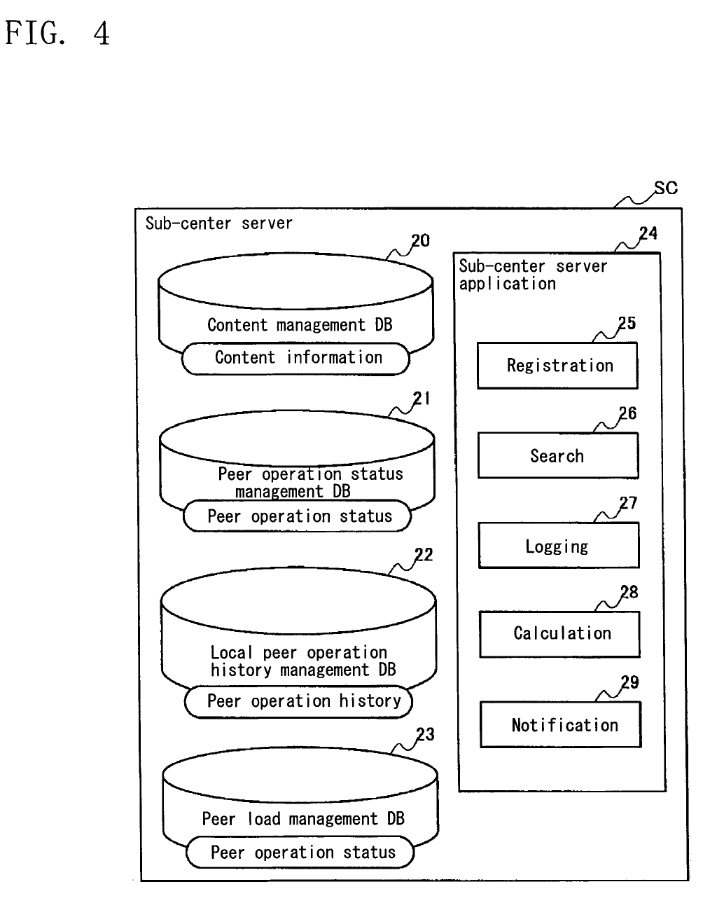

Referring to FIG. 4, the sub-center server SC includes a content management database 20 for storing content information, a peer operation status management database 21 for storing peer operation statuses, a local peer operation history management database 22 for storing peer operation histories, a peer load management database 23 for storing peer load values, and a sub-center server application 24 for controlling the sub-center server SC.

The content information stored in the content management database 20 is content information of content items present in the dynamic cache peers CP and the dynamic peers DP in the realm network, the particulars of which will be described later. The peer operation statuses stored in the peer operation status management database 21 are operation statuses of the dynamic peers DP and the dynamic cache peers CP (the description will hereinafter be directed only to the “dynamic peers DP” for the sake of simplicity) in the realm network, including POWER ON, POWER OFF, DOWNLOAD STARTED, DOWNLOAD COMPLETED, CONTENT REPRODUCTION STARTED, and CONTENT REPRODUCTION STOPPED, for example. The peer operation histories stored in the local peer operation history management database 22 are operation histories of the dynamic peers DP and the dynamic cache peers CP (the description will hereinafter be directed only to the “dynamic peers DP” for the sake of simplicity) in the realm network, and are chronological records of the peer operation statuses. The peer load values stored in the peer load management database 23 are values representing the loads on the dynamic cache peers CP and the dynamic peers DP in the realm network.

Specifically, the sub-center server application 24 includes: a registration section 25 for registering, in the content management database 20, content information sent from the dynamic cache peers CP and the dynamic peers DP in the realm network; a search section 26 for performing a search operation through the content management database 20 according to a query issued from a dynamic peer DP in the realm network to produce a list of desired content items and send the produced list back to the dynamic peer DP; a logging section 27 for registering the peer operation status sent from a dynamic peer DP in the realm network in the peer operation status management database 21 to update the database and for storing the peer operation history in the local peer operation history management database 22; a calculation section 28 for calculating the value of the load on each of the dynamic cache peers CP and the dynamic peers DP in the realm network and registering the calculated value in the peer load management database 23; and a notification section 29 for periodically notifying the main center server MC of the peer operation histories stored in the local peer operation history management database 22.

Configuration Of Content Management Database

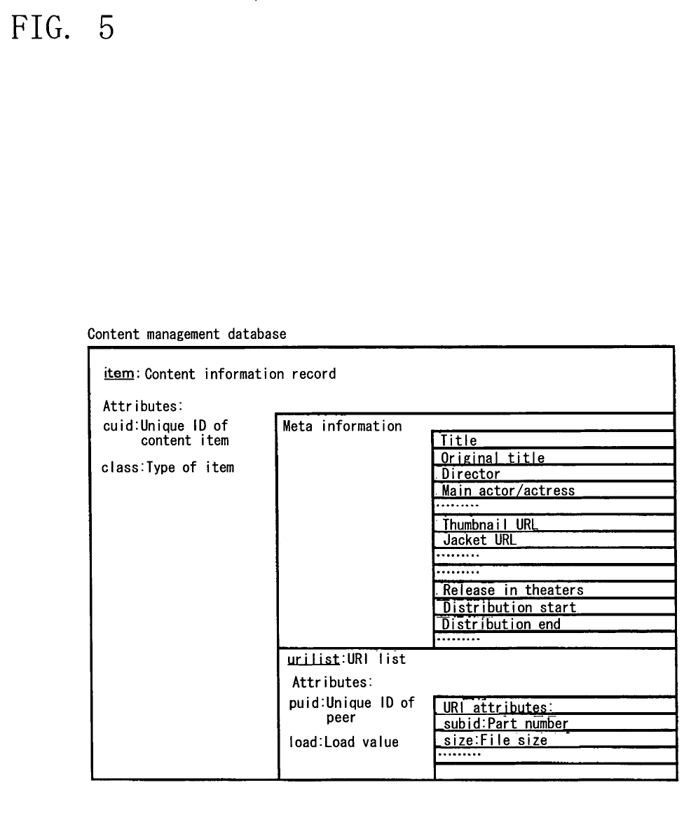

FIG. 5 shows a configuration of the content management database 20. Other content management databases to be described below have the same configuration.

The content management database 20 includes a number of content information records (‘item’), and the number of content information records is equal to the total number of content items. Each content information record (‘item’) includes meta information and one or more URI lists (‘urilist’). The attributes of the content information record (‘item’) include the unique ID (‘cuid’) of the content item and the type (‘class’) of the content item (“video”, “music”, etc.).

The meta information represents the particulars of the content item, including the title of the content item, the name of the director, and the name of the leading actor/actress. The URI list (‘urilist’) is location information representing the location of the content item. The number of URI lists (‘urilist’) included in a content information record (‘item’) is equal to the number of the peers CP and DP in the realm network that have the content item stored therein. The attributes of the URI list (‘urilist’) include the unique ID (‘puid’) of the peer CP or DP having the content item stored therein, and the load value (‘load’) of the peer CP or DP.

A content item stored in a peer CP or DP is divided into one or more files. The URI list (‘urilist’) includes one or more URIs indicating the locations of these files. The attributes of the URI include the part number (‘subid’) and the file size (‘size’) of each file.

Center Network

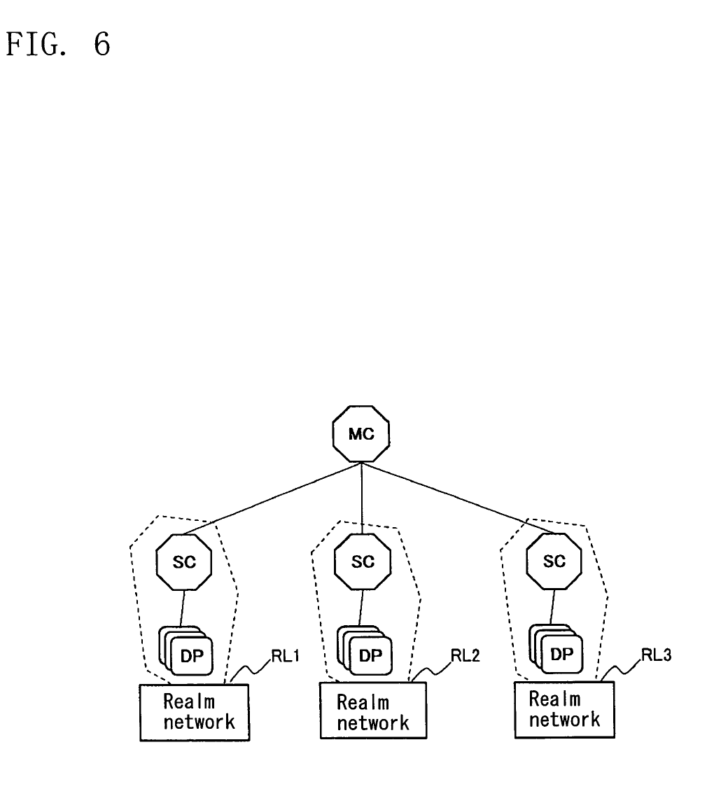

Referring to FIG. 6, in each of the realm networks RL1 to RL3, the sub-center server SC constantly monitors the operation statuses of all the dynamic peers DP and the dynamic cache peers CP (the description will hereinafter be directed only to the “dynamic peers DP” for the sake of simplicity) in the realm network, and collectively uploads the operation histories to the main center server MC. Therefore, the operation histories of all the dynamic peers DP in the realm networks RL1 to RL3 are collected in the main center server MC. The main center server MC calculates the charge for the use of content items for each dynamic peer DP based on the collected operation histories, and performs a billing operation.

As a result, the sub-center server SC is free from the billing operation and can devote itself to the history information collecting operation, which is a real-time operation, and the main center server MC is free from the history information collecting operation and can devote itself to the billing operation.

When new dynamic peers DP are added, a new realm network can be configured by adding a new sub-center server SC and placing the new dynamic peers DP under the new sub-center server SC. Thus, it is possible to easily increase the scale of the content distribution system. Moreover, as the number of sub-center servers SC increases, new main center servers MC may be added.

Realm Network

In each of the realm networks RL1 to RL3, there is only one sub-center server SC. The sub-center server SC collects the content information of content items stored in the dynamic peers DP in the realm network, and makes the collected content information open to the dynamic peers DP. A dynamic peer DP can access a peer CP or DP storing a desired content item based on an URL contained in the content information to download the desired content item therefrom.

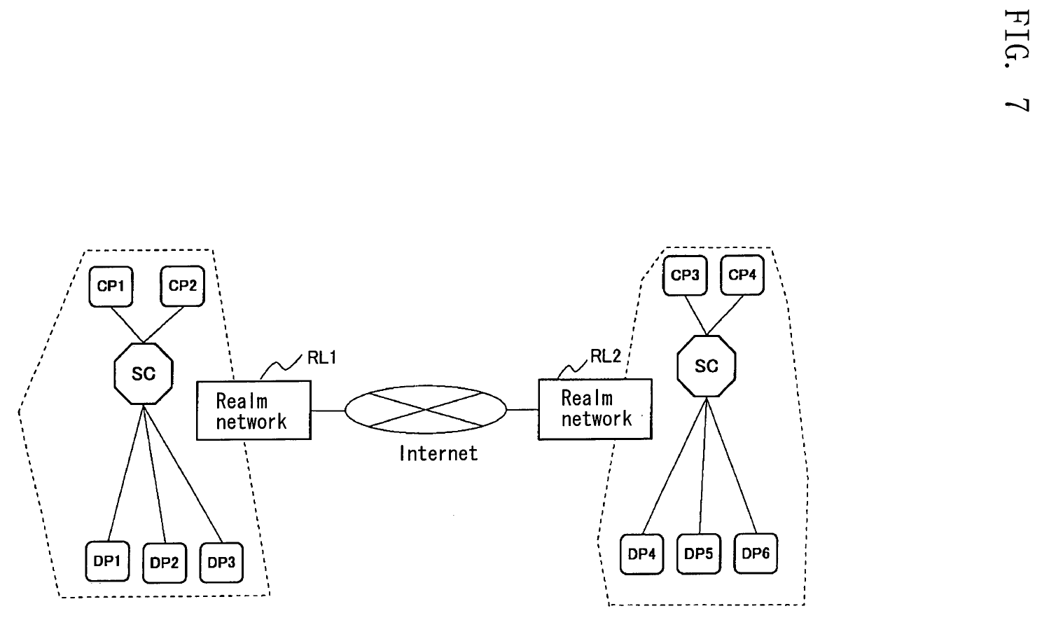

Referring to FIG. 7, only the URLs of the dynamic cache peers CP1 and CP2 and dynamic peers DP1 to DP3 appear in the content information made open by the sub-center server SC of the realm network RL1. Therefore, dynamic peers DP4 to DP6 cannot access the dynamic cache peers CP1 and CP2 and the dynamic peers DP1 to DP3 outside the realm network RL2.

Configuration Of Cache Center Server

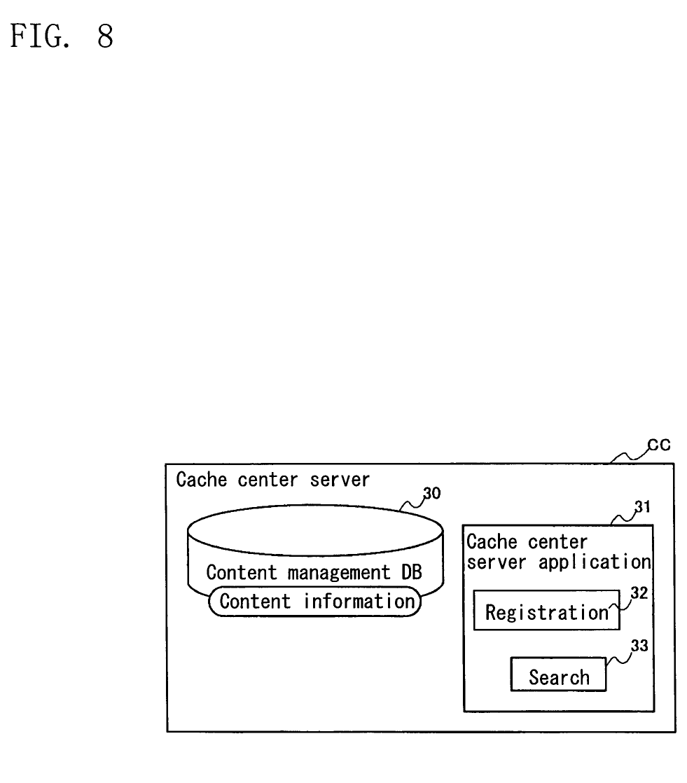

Referring to FIG. 8, the cache center server CC includes a content management database 30 for storing content information, and a cache center server application 31 for controlling the cache center server CC.

Specifically, the cache center server application 31 includes a registration section 32 for registering, in the content management database 30, the content information sent from the static peer SP, and a search section 33 for performing a search operation through the content management database 30 according to a query issued from the dynamic cache peer CP to produce a list of desired content items and send the produced list back to the dynamic cache peer CP.

Configuration Of Static Peer

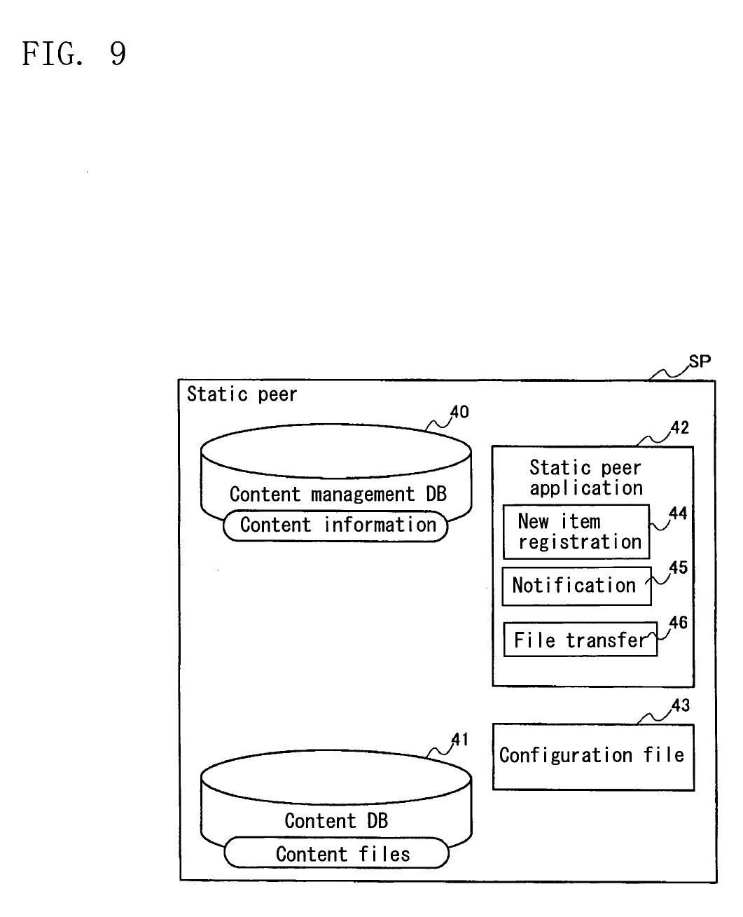

Referring to FIG. 9, the static peer SP includes a content management database 40 for storing content information, a content database 41 for storing content files, a static peer application 42 for controlling the static peer SP, and a configuration file 43 for configuring the cache network CA.

Specifically, the static peer application 42 includes a new item registration section 44 for registering content information of a new content item to be distributed in the content management database 30 and registering the content file in the content database 41, a notification section 45 for notifying the cache center server CC of the content information registered in the content management database 30, and a file transfer section 46 for transferring a desired content file to a dynamic cache peer CP in the cache network CA in response to a request from the dynamic cache peer CP.

Configuration Of Dynamic Cache Peer

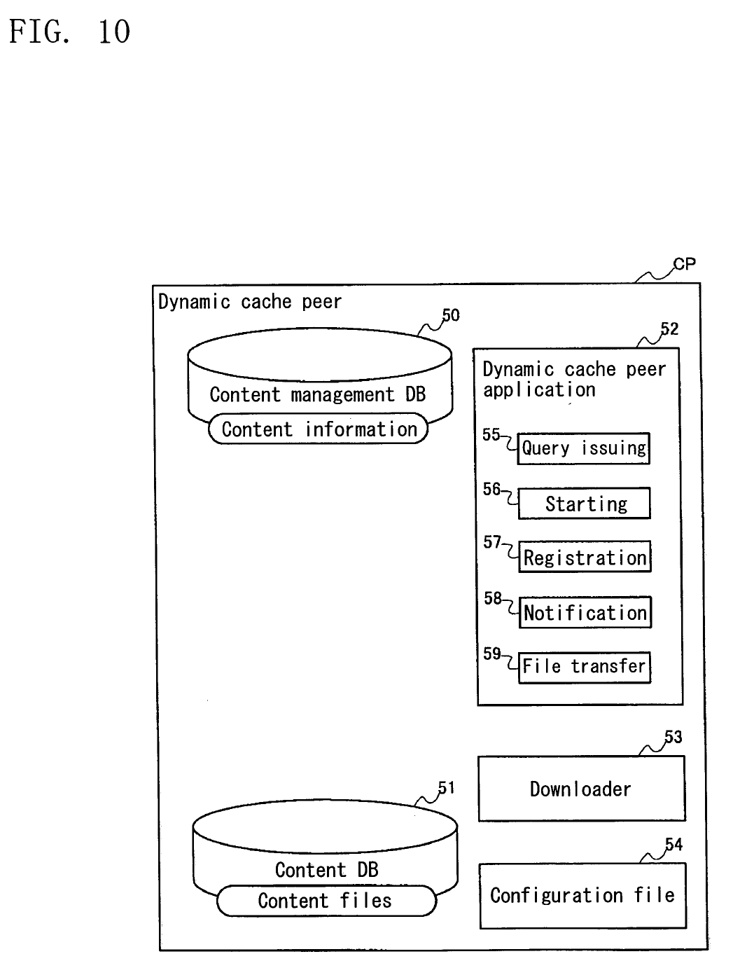

Referring to FIG. 10, the dynamic cache peer CP includes a content management database 50 for storing content information, a content database 51 for storing content files, a dynamic cache peer application 52 for controlling the dynamic cache peer CP, a downloader 53 for downloading a desired content file from the static peer SP or another dynamic cache peer CP, and a configuration file 54 for configuring the cache network CA or the realm networks RL1 to RL5.

Specifically, the dynamic cache peer application 52 includes: a query issuing section 55 for issuing a predetermined query to obtain a content list from the cache center server CC; a starting section 56 for starting the downloader 53; a registration section 57 for registering the content information of a downloaded content item in the content management database 50 and notifying the sub-center server SC (the cache center server CC and the sub-center server SC in the case of the dynamic cache peers CP1 and CP2 being first-level caches) of the content information; a notification section 58 for notifying the sub-center server SC (the sub-center server SC and the cache center server CC in the case of the dynamic cache peers CP1 and CP2 being first-level caches) of the operation status of the dynamic cache peer CP; and a file transfer section 59 for transferring a desired content file to a dynamic peer DP in the realm network (another dynamic cache peer CP in the cache network CA or a dynamic peer DP in the realm network in the case of the dynamic cache peers CP1 and CP2 being first-level caches) in response to a request from the dynamic peer DP (the dynamic cache peer CP or the dynamic peer DP in the case of the dynamic cache peers CP1 and CP2 being first-level caches).

Configuration Of Dynamic Peer

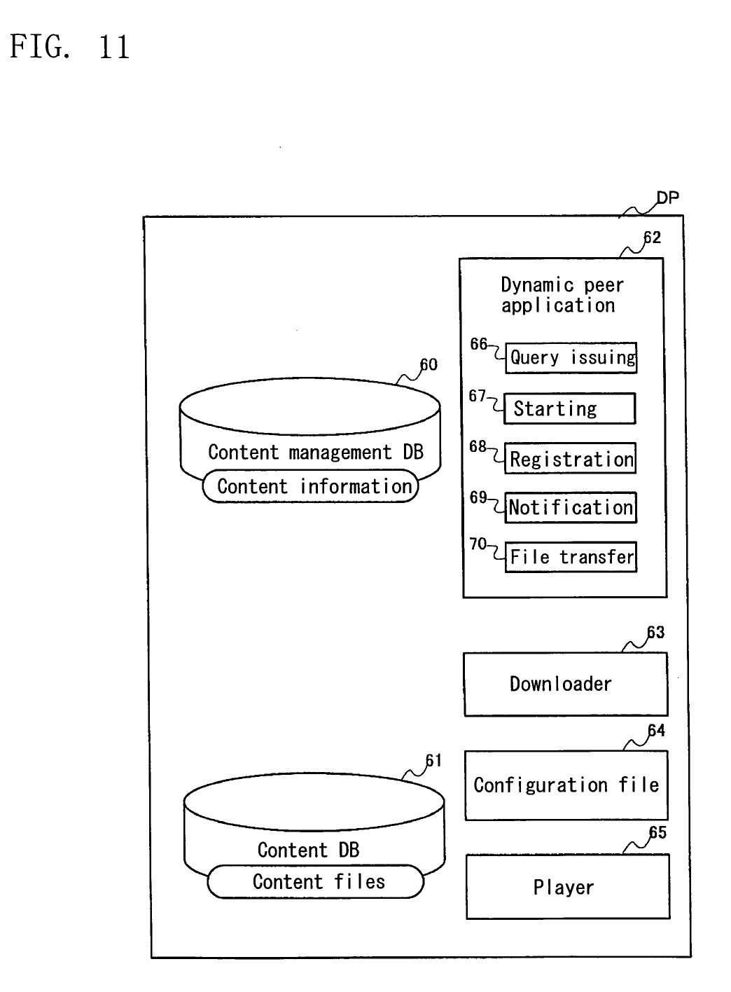

Referring to FIG. 11, the dynamic peer DP includes a content management database 60 for storing content information, a content database 61 for storing content files, a dynamic peer application 62 for controlling the dynamic peer DP, a downloader 63 for downloading a desired content file from the dynamic cache peer CP or another dynamic peer DP, a configuration file 64 for configuring the realm networks RL1 to RL5, and a player 65 for reading out a desired content file from the content database 61 and reproducing the content item.

Specifically, the dynamic peer application 62 includes: a query issuing section 66 for issuing a desired query to obtain a content list from the sub-center server SC; a starting section 67 for starting the downloader 63; a registration section 68 for registering the content information of a downloaded content item in the content management database 60; a notification section 69 for notifying the sub-center server SC of the operation status of the dynamic peer DP; a file transfer section 70 for reading out a desired content file from the content database 61 and transferring the desired content file to another dynamic peer DP in the realm network in response to a request from the dynamic peer DP.

Peer Configuration

Table 1 below shows the structure of the configuration files 43, 54 and 64 included in the peers CP, DP and SP. Registered in these files in advance are the unique ID of the peer, the URI of the peer itself, the operation mode of the peer, a flag indicating whether or not the peer is capable of uploading files, the URI of the upstream-side center server to which the operation status of the peer is to be sent, the URI of the upstream-side center server to which the content information is to be sent, the URI of the downstream-side center server to which the operation status of the peer is to be sent, the URI of the downstream-side center server to which the content information is to be sent, the collection rule (the rule based on which content items are collected), etc. While the URI to which the peer operation status is to be sent is the same as the URI to which the content information is to be sent in the following example, they may be different URIs.

TABLE 1

| Item | Description |
|---|---|
| puid | Unique ID of the peer |
| urlbase | (Unvaried portion of) URL of itself |
| mode | Operation mode of the peer (static, dynamic, cache) |
| uploadavailable | Indicates whether the peer is capable of uploading |
| | files |
| docroot | Directory where data is placed |
| dirmetadata | When combined with docroot, indicates directory |
| | where meta data is placed |
| dircontents | When combined with docroot, indicates directory |
| | where content items are placed |
| urlpeerdb | Operation status notification URL (upstream-side |
| | center) |
| urlcontentdb | Content information notification URL |
| | (upstream-side center) |
| lower_urlpeerdb | Operation status notification URL |
| | (downstream-side center) |
| lower_urlcontentdb | Content information notification URL |
| | (downstream-side center) |
| rule | Collection rule (search query, e.g., schedule, |
| | peer, genre, etc.) |

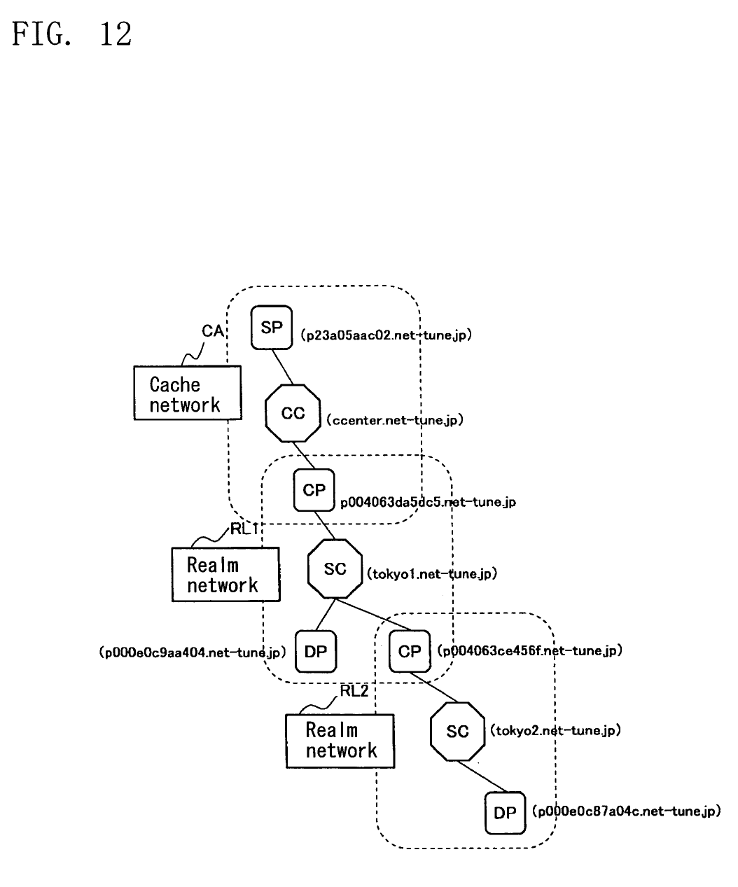

An example of a configuration setting for configuring the cache network CA and the realm networks RL1 and RL2 as shown in FIG. 12 will now be described.

The configuration setting for the dynamic cache peer CP1 being a first-level cache may be as shown in Table 2 below, for example. In this example, the URI of the cache center server CC is registered as the upstream-side center server, and the URI of the sub-center server SC is registered as the downstream-side center server.

TABLE 2

| Item | Description |
|---|---|
| puid | 004063da5dc500000000000000000000 |
| urlbase | https://p004063da5dc5.net-tune.jp |
| mode | cache |
| uploadavailable | 1 |
| docroot | /home/document |
| dirmetadata | metadata |
| dircontents | contents |
| urlpeerdb | https://ccenter.net-tune.jp/cgi-bin/nds-peerdb.cgi |
| urlcontentdb | https://ccenter.net-tune.jp/cgi-bin/nds-peerdb.cgi |
| lower_urlpeerdb | https://tokyo1.net-tune.jp/cgi-bin/nds-peerdb.cgi |
| lower_urlcontentdb | https://tokyo1.net-tune.jp/cgi-bin/nds-peerdb.cgi |
| rule | peer = 000e0c9e054f00000000000000000000 |

The configuration setting for the dynamic cache peer CP3 being a second- or subsequent-level cache may be as shown in Table 3 below, for example. In this example, the URI of the upstream-side sub-center server SC is registered as the upstream-side center server, and the URI of the downstream-side sub-center server SC is registered as the downstream-side center server.

TABLE 3

| Item | Description |
|---|---|
| puid | 004063ce456f00000000000000000000 |
| urlbase | https://p004063ce456f.net-tune.jp |
| mode | cache |
| uploadavailable | 1 |
| docroot | /home/document |
| dirmetadata | metadata |
| dircontents | contents |
| urlpeerdb | https://tokyo1.net-tune.jp/cgi-bin/nds-peerdb.cgi |
| urlcontentdb | https://tokyo1.net-tune.jp/cgi-bin/nds-peerdb.cgi |
| lower_urlpeerdb | https://tokyo2.net-tune.jp/cgi-bin/nds-peerdb.cgi |
| lower_urlcontentdb | https://tokyo2.net-tune.jp/cgi-bin/nds-peerdb.cgi |
| rule | peer = 004063da5dc500000000000000000000 |

The configuration setting for the dynamic peers DP may be as shown in Tables 4 and 5 below, for example. In these examples, while the URI of the sub-center server SC is registered as the upstream-side center server, no URI is registered as the downstream-side center server. Even if any data is registered in these fields, such data is ignored.

TABLE 4

| Item | Description |
|---|---|
| puid | 000e0c9aa40400000000000000000000 |
| urlbase | https://p000e0c9aa404.net-tune.jp |
| mode | dynamic |
| uploadavailable | 0 |
| docroot | /home/document |
| dirmetadata | metadata |
| dircontents | contents |
| urlpeerdb | https://tokyo1.net-tune.jp/cgi-bin/nds-peerdb.cgi |
| urlcontentdb | https://tokyo1.net-tune.jp/cgi-bin/nds-peerdb.cgi |
| lower_urlpeerdb | |
| lower_urlcontentdb | |
| rule | schedule |

TABLE 5

| Item | Description |
|---|---|
| puid | 000e0c87a04c00000000000000000000 |
| urlbase | https://p000e0c87a04c.net-tune.jp |
| mode | dynamic |
| uploadavailable | 1 |
| docroot | /home/document |
| dirmetadata | metadata |
| dircontents | contents |
| urlpeerdb | https://tokyo2.net-tune.jp/cgi-bin/nds-peerdb.cgi |
| urlcontentdb | https://tokyo2.net-tune.jp/cgi-bin/nds-peerdb.cgi |
| lower_urlpeerdb | |
| lower_urlcontentdb | |
| rule | schedule |

In Table 4, which is for a dynamic peer DP that is not capable of uploading files, the UPLOAD AVAILABLE flag is set to “0”. In Table 5, which is for a dynamic peer DP that is capable of uploading files, the UPLOAD AVAILABLE flag is set to “1”.

The configuration setting for the static peer SP may be as shown in Table 6 below, for example. In this example, while the URI of the cache center server CC is registered as the upstream-side center server, no URI is registered as the downstream-side center server. Even if any data is registered in these fields, such data is ignored.

TABLE 6

| Item | Description |
|---|---|
| puid | 0023a05aac0200000000000000000000 |
| urlbase | https://p0023a05aac02.net-tune.jp |
| mode | static |
| uploadavailable | 1 |
| docroot | /home/document |
| dirmetadata | metadata |
| dircontents | contents |
| urlpeerdb | https://ccenter.net-tune.jp/cgi-bin/nds-peerdb.cgi |
| urlcontentdb | https://ccenter.net-tune.jp/cgi-bin/nds-peerdb.cgi |
| lower_urlpeerdb | |
| lower_urlcontentdb | |
| rule | |

Typically, a predetermined schedule (program guide) is registered as the collection rule in the configuration file 64 for a dynamic peer DP. Therefore, the dynamic peer DP issues queries according to the schedule.

Typically, the unique ID of the static peer SP or another dynamic cache peer CP is registered as the collection rule in the configuration file 54 for the dynamic cache peer CP. Therefore, the dynamic cache peer CP performs a mirroring operation to keep in itself a complete duplicate of data stored in the peer registered as the collection rule.

If, in the example shown in FIG. 2, the unique ID of the static peer SP is registered as the collection rule for the dynamic cache peers CP1 and CP2, the dynamic cache peers CP1 and CP2 collect all the content items of the static peer SP, thus functioning as a cache of the static peer SP in the realm networks RL1 and RL4. Similarly, if the unique ID of the dynamic cache peer CP1 is registered as the collection rule for the dynamic cache peer CP3, the dynamic cache peer CP3 functions as a cache of the dynamic cache peer CP1 in the realm network RL2. Similarly, if the unique ID of the dynamic cache peer CP3 is registered as the collection rule for the dynamic cache peer CP5, the dynamic cache peer CP5 functions as a cache of the dynamic cache peer CP3 in the realm network RL3. Similarly, if the unique ID of the dynamic cache peer CP2 is registered as the collection rule for the dynamic cache peer CP4, the dynamic cache peer CP4 functions as a cache of the dynamic cache peer CP2 in the realm network RL5.

While such a collection rule is used primarily for mirroring data of an upper-level peer in a dynamic cache peer CP, it may also be used for mirroring data between dynamic peers DP.

Other examples of the collection rule may include the name of a director, the name of an actor/actress, a genre, a country of production, etc. For example, if the name of a director is registered in a dynamic peer DP, the dynamic peer DP will automatically collect movies (content items) directed by that director. Alternatively, if a genre is registered in a dynamic cache peer CP, the dynamic cache peer CP will automatically collect movies of that genre. Thus, it is possible to configure a dynamic cache peer CP dedicated to a particular area of interest. If a dynamic cache peer CP is configured to collect particular content items that are popular in a realm network, such content items can be quickly distributed among the dynamic peers DP.

Operation Of Dynamic Peer

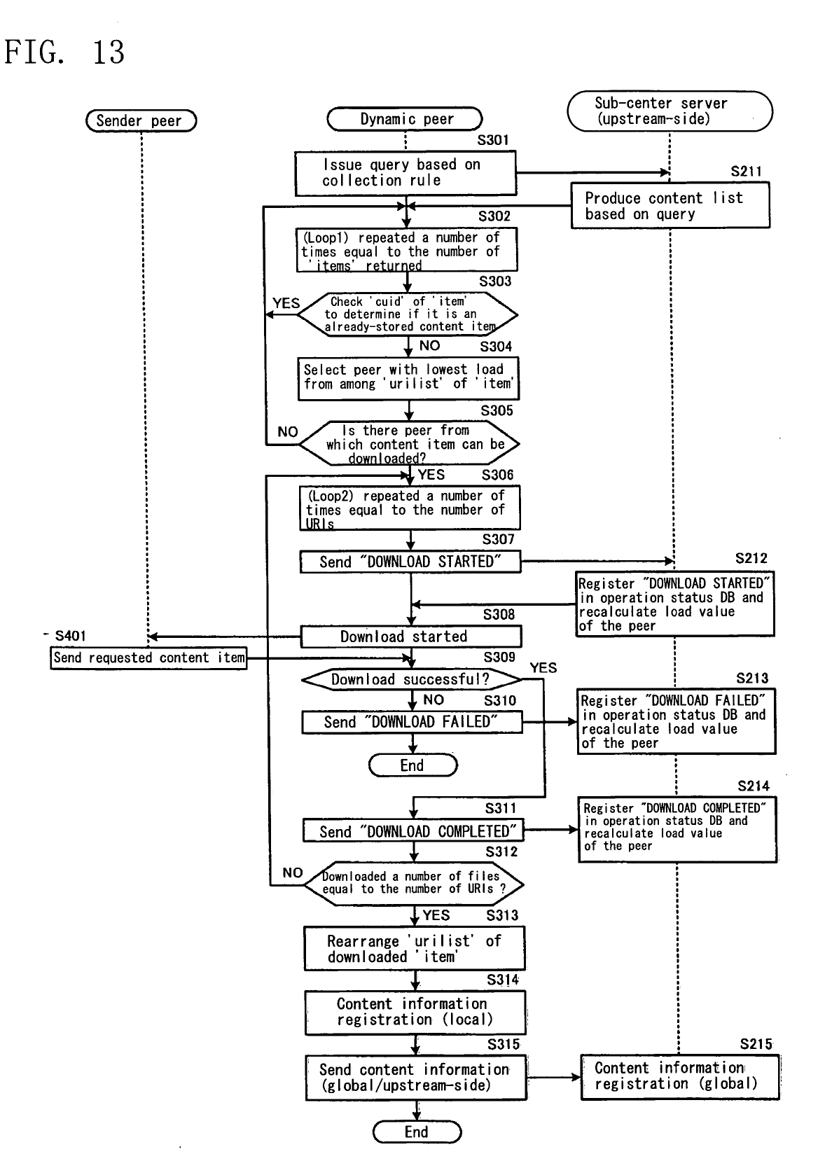

Next, an operation of the dynamic peer DP will be described with reference to FIG. 13. The dynamic peer DP performs predetermined operations with the dynamic cache peer CP or another dynamic peer DP and with the sub-center server SC according to the dynamic peer application 62.

First, the dynamic peer DP issues a query based on a predetermined collection rule and sends the query to the sub-center server SC (S301). In response to this, the sub-center server SC produces a content list based on the query issued from the dynamic peer DP, and sends the produced content list back to the dynamic peer DP which issued the query (S211).

The collection rule for each dynamic peer DP is created in advance through the operation by the user of the dynamic peer DP. For example, a collection rule may be created based on the name of the director or the name of the leading actor/actress according to the user's preference. Then, the sub-center server SC performs a search through the content management database 20 by the name of the director or the name of the leading actor/actress to retrieve one or more content information records (‘item’), and produces a content list including the content information records (‘item’).

The dynamic peer DP repeats the following steps (steps S303 to S305) a number of times equal to the number of content information records (‘item’) included in the received content list (S302).

Specifically, the dynamic peer DP compares the unique ID (‘cuid’) of each content item included in the content information record (‘item’) with the unique ID (‘cuid’) of each content item registered in the content management database 60 of the dynamic peer DP to determine whether or not the dynamic peer DP already has the listed content item stored therein (S303). If the dynamic peer DP already has the listed content item stored therein (YES in S303), the dynamic peer DP returns to step S302 to check the next content information record (‘item’).

If the dynamic peer DP does not have the listed content item stored therein (NO in S303), the dynamic peer DP selects a URI list (‘urilist’) that has the smallest load value (‘load’) (excluding negative load values) from among one or more URI lists (‘urilist’) included in the content information record (‘item’), thus selecting a peer CP or DP with the lowest load (S304).

If there is no peer from which the content item can be downloaded (NO in S305), the dynamic peer DP returns to step S302 to check the next content information record (‘item’).

If there is a peer from which the content item can be downloaded (YES in S305), the dynamic peer DP repeats the following steps (steps S307 to S312) a number of times equal to the number of URIs included in the selected URI list (‘urilist’) (S306).

Specifically, the dynamic peer DP sends the operation status DOWNLOAD STARTED (‘dlstart’) to the sub-center server SC (S307). In response to this, the sub-center server SC registers the operation status DOWNLOAD STARTED (‘dlstart’) in the peer operation status management database 21, and recalculates the load value of the dynamic peer DP to update the load value (‘load’) in the content management database 20 and the peer load management database 23 (S212).

Then, the dynamic peer DP starts the downloader 63 to request the peer CP or DP with the lowest load to send the content item and downloads the content item (S308). In response to this, the requested peer CP or DP sends a file of the requested content item to the requesting dynamic peer DP (S401).

If the download fails (NO in S309), the dynamic peer DP sends the operation status DOWNLOAD FAILED (‘dlfailed’) to the sub-center server SC (S310). In response to this, the sub-center server SC registers the operation status DOWNLOAD FAILED (‘dlfailed’) in the peer operation status management database 21, and recalculates the load value of the dynamic peer DP to update the load value (‘load’) in the content management database 20 and the peer load management database 23 (S213).

If the download is successful (YES in S309), the dynamic peer DP sends the operation status DOWNLOAD COMPLETED (‘dlcompleted’) to the sub-center server SC (S311). In response to this, the sub-center server SC registers the operation status DOWNLOAD COMPLETED (‘dlcompleted’) in the peer operation status management database 21, and recalculates the load value of the dynamic peer DP to update the load value (‘load’) in the content management database 20 and the peer load management database 23 (S214).

These steps (steps S307 to S311) are repeated until one or more files, into which the content item has been divided, are all downloaded (S312).

Then, the dynamic peer DP rearranges the URI list (‘urilist’) of the downloaded content item (S313). Specifically, the dynamic peer DP deletes the URIs of the other peers from the URI list of the content item so that there is only the URI of the dynamic peer DP in the URI list. Thus, the data size of the content information can be reduced, and the URI of the peer having newly downloaded a content item can be registered in the content management database 20.

Then, the dynamic peer DP registers the downloaded content item and the content information thereof in the content database 61 and in the content management database 60 (S314).

Then, the dynamic peer DP sends the registered content information to the sub-center server SC (S315). In response to this, the sub-center server SC registers the content information sent from the dynamic peer DP in the content management database 20 (S215).

Operation Of Dynamic Cache Peer

The operation of the dynamic cache peer CP will now be described. The operation of the dynamic cache peer CP is basically the same as that of the dynamic peer DP shown in FIG. 13. Thus, the above description of the operation of the dynamic peer DP is incorporated herein by reference while replacing the term “dynamic peer” with “dynamic cache peer”, “dynamic cache peer” with “static cache peer”, and “sub-center server” with “cache center server”.

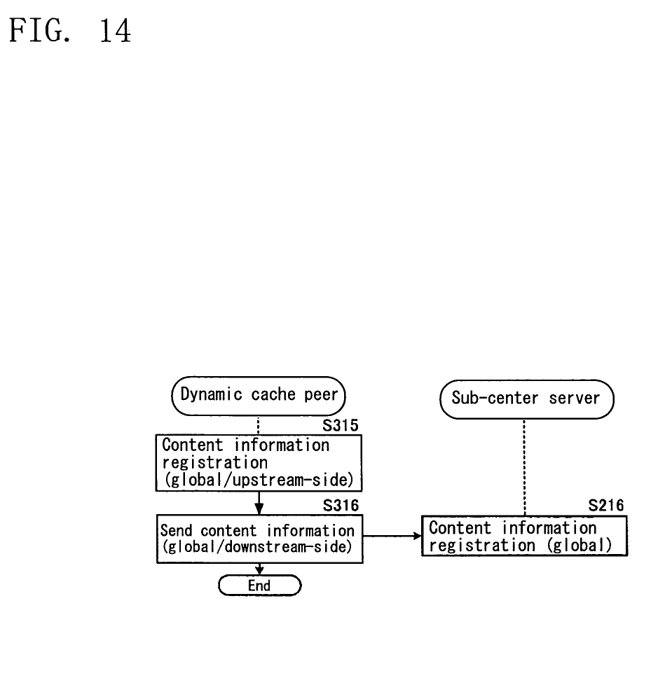

The dynamic cache peer CP performs operations as shown in FIG. 13 with the static peer SP or another dynamic cache peer CP and with the cache center server CC according to the dynamic cache peer application 52. Note however that the dynamic cache peers CP1 and CP2, which are first-level caches, perform operations as shown in FIG. 14, in addition to those shown in FIG. 13. Specifically, the dynamic cache peer CP sends registered content information to the cache center server CC (S315), and sends the same content information also to the sub-center server SC (S316).

As described above, according to the embodiment of the present invention, the dynamic peers DP are distributed among realm networks RN1 to RN5, with each realm network forming a P2P system including the sub-center server SC, whereby it is possible to distribute the load among the dynamic peers DP. As a result, an increase in the number of the dynamic peers DP can be made easily.

The sub-center servers SC are also distributed among the realm networks RN1 to RN5, whereby it is possible to distribute the load among the sub-center servers SC.

Moreover, the cache network CA also forms a P2P system including the cache center server CC, whereby it is possible to reduce the load on the static peer SP by distributing it among the dynamic cache peers CP.

If realm networks are formed by the unit of organizations such as internet service providers or carriers, a very large number of content files will be transferred within each internet service provider or carrier, rather than between the internet service providers and carriers.

While the cache network CA is formed as a P2P system in the embodiment described above, it may alternatively be a client-server system. In such a case, the cache center server CC is not needed, with the static peer SP serving as a server and the dynamic cache peers CP serving as clients.

While the present invention has been described above in a preferred embodiment, it is understood that the embodiment is merely illustrative of how the invention may be carried out, and it is apparent to those skilled in the art that variations and modifications thereof can be made without departing from the spirit and scope of the invention.

What is claimed is:

1. A peer-to-peer content distribution system, comprising:
a static peer; and
a plurality of realm networks, wherein:
each realm network includes:
a center server;
a dynamic cache peer connected to the static peer and the center server; and
a plurality of dynamic peers connected to the center server, to the dynamic cache peer, and to one another;
the static peer includes a first content storage section for storing a content file;
each center server includes a first content information storage section for storing content information regarding particulars and a location of each content item;
each dynamic cache peer includes:
a second content storage section for storing a content file; and
a first downloading section for downloading a content file from the static peer to store the downloaded content file in the second content storage section; and
each dynamic peer includes:
a third content storage section for storing a content file;
a section for obtaining content information from the center server in the realm network;
a second downloading section for downloading a content file from the dynamic cache peer or another dynamic peer in the realm network based on the obtained content information to store the downloaded content file in the third content storage section; and
a content reproduction section for reading out a content file from the third content storage section to reproduce the content item.

2. The peer-to-peer content distribution system according to claim 1, further comprising a cache center server, wherein:
the static peer is connected to the cache center server;
the plurality of dynamic cache peers are connected to the cache center server and to one another;
the cache center server includes a second content information storage section for storing content information;
each dynamic cache peer further includes a section for obtaining content information from the cache center server; and
the first downloading section downloads a content file from the static peer or another dynamic cache peer based on the obtained content information.

3. The peer-to-peer content distribution system according to claim 2, wherein:
each dynamic peer further includes a section for notifying the center server of content information of the content item downloaded by the second downloading section; and
each dynamic cache peer further includes a section for notifying the cache center server and the center server in the realm network of content information of the content item downloaded by the first downloading section.

4. The peer-to-peer content distribution system according to claim 1, further comprising a second dynamic cache peer connected to the center server and the dynamic cache peer in the realm network, and also connected to the center server and the dynamic peers in another realm network, wherein:
the second dynamic cache peer includes:
a fourth content storage section for storing a content file; and
a third downloading section for downloading a content file from the dynamic cache peer to store the downloaded content file in the fourth content storage section; and
each dynamic peer in the other realm network downloads a content file from the second dynamic cache peer to store the downloaded content file in the third content storage section.

5. The peer-to-peer content distribution system according to claim 4, wherein:
each second dynamic cache peer further includes a section for notifying the center server in the realm network and the center server in the other realm network of content information of the content item downloaded by the third downloading section.

6. The peer-to-peer content distribution system according to claim 1, further comprising a main center server, wherein:
each center server is connected to the main center server;
the main center server includes:
a global peer operation history storage section for storing a peer operation history; and
a billing section for calculating a charge for use of content items based on the peer operation history stored in the global peer operation history storage section;
each center server further includes:
a local peer operation history storage section for storing a peer operation history of each dynamic peer in the realm network representing a history of operation statuses of the dynamic peer; and
a peer operation history notification section for notifying the main center server of the peer operation history stored in the local peer operation history storage section; and
each dynamic peer further includes an operation status notification section for notifying the center server of an operation status of itself.

7. A peer-to-peer content distribution system, comprising:
a main center server; and
a plurality of realm networks;
each realm network includes:
a sub-center server connected to the main center server; and
a plurality of peers connected to the sub-center server and to one another;
the main center server includes:
a global peer operation history storage section for storing a peer operation history; and
a billing section for calculating a charge for use of content items based on the peer operation history stored in the global peer operation history storage section;
each sub-center server includes:
a content information storage section for storing content information regarding particulars of each content item and a location of each content file;
a local peer operation history storage section for storing a peer operation history of each peer in the realm network representing a history of operation statuses of the peer; and
a peer operation history notification section for notifying the main center server of the peer operation history stored in the local peer operation history storage section; and
each peer includes:
a content storage section for storing a content file;
a content information obtaining section for obtaining content information from the sub-center server;
a downloading section for downloading a content file from another peer in the realm network based on the content information obtained by the content information obtaining section to store the downloaded content file in the content storage section;
a content reproduction section for reading out a content file from the content storage section to reproduce the content item; and
an operation status notification section for notifying the sub-center server of an operation status of itself.
